(19) United States
(12) Patent Application Publication
(10) Pub. No.: US 2014/0345800 A1
(43) Pub. Date: Nov. 27, 2014

(54) AUTOMATED DEVICE FOR PLASMA SURFACE PREPARATION OF A THERMOPLASTIC PART

(71) Applicants: Jean-Gilles Kerbiguet, Le Chesnay (FR); Thomas Pollet, Voisins Le Bretonneux (FR)

(72) Inventors: Jean-Gilles Kerbiguet, Le Chesnay (FR); Thomas Pollet, Voisins Le Bretonneux (FR)

(73) Assignee: RENAULT s.a.s., Boulogne-Billancourt (FR)

(21) Appl. No.: 14/365,399

(22) PCT Filed: Nov. 30, 2012
(86) PCT No.: PCT/EP2012/074040

§ 371 Date: Jun. 13, 2014

(30) Foreign Application Priority Data
Dec. 15, 2011 (FR) 1161686

(51) Int. Cl. B05D 3/14

(52) U.S. Cl. CPC B05D 3/144
USPC 156/345.24

(57) ABSTRACT

An automated device for plasma surface preparation of a thermoplastic part including a first support mechanism for a thermoplastic part and a second support mechanism for a plasma torch including a rotating cylindrical tip, the first and/or second support mechanism being movable so that the torch and the part have a relative movement enabling the torch to travel over a treatment zone of the part. The device further includes, on the plasma torch, a controller controlling a distance between the tip of the torch and the part. The controller includes a measuring rod positioned axially on the tip of the plasma torch. The device further includes a carriage that can be moved in the direction of the axis of the torch interposed between the movable torch and the second support mechanism. The movable carriage counteracts a displacement about an equilibrium or stop position.

The present invention relates to a robotic device for preparing a surface of a thermoplastic part with plasma, especially in the context of the surface preparation of zones in which thermoplastic parts used in the automotive industry are coated with adhesive.

In robotic plasma surface preparation of thermoplastics (coating zones), it is recommended to control with precision the distance between the end-fitting of the plasma torch and the surface of the part to be treated in order to guarantee a good surface tension, which is an indispensable prerequisite of good adhesion of primers and adhesives to this type of material. However, in the context of an automated solution consisting in loading the part to be treated onto a handling robot and passing it at high speed under the plasma torch, the risks of divergence run with this type of robotic process are high.

The aim of the invention is to solve this problem and to implement dynamically control/measurement solutions when divergence tolerances are very tight and the process is unable to respect them and/or the material to be treated requires it.

The invention achieves its aim by virtue of a robotic device for preparing a surface of a thermoplastic part with plasma, this device comprising, on the one hand, first means for holding a thermoplastic part and, on the other hand, second means for holding a plasma torch having a rotary cylindrical end-fitting, the first and/or second holding means being movable so that the torch and the part have a relative movement allowing the torch to travel over a treatment zone of the part, the device comprising, on the plasma torch, means for controlling the distance between the end-fitting of the torch and the part, characterized in that the controlling means comprise a rod placed axially on the end-fitting of the plasma torch, thereby allowing a simple mechanical solution to be obtained, advantageously associated with the means for producing a counter-reaction mentioned below in order to guarantee that the rod bears against the part, in that the device comprises a carriage that is movable in the direction of the axis of the torch, which carriage is interposed between the movable torch and the second holding means (especially a scaffold), and in that the movable carriage comprises means for producing a counter-reaction to a movement about a position of equilibrium or abutment, so as to return the carriage, and therefore the torch, to this position of equilibrium or abutment.

By virtue of these means, it is possible to control the distance between the tool and the part dynamically and/or to control online 100% of the parts in order to guarantee a high preparation quality, to make development easier and to prevent and correct possible drift in production.

According to other features of the invention, which may be applied individually or in combination:

the first holding means (or the second holding means) consist of a handling robot, especially with an articulated arm;

the second holding means (or the first holding means) consist of a fixed scaffold;

the movable carriage comprises motorized means for moving the torch in the direction of its axis, thereby allowing, in certain embodiments, possible drifts, detected by measurement of the distance between the torch and the part, to be corrected in real time;

the controlling means comprise a rod placed axially on the end-fitting of the plasma torch; and

the rod comprises a caged ball at its end, so as not to mark the part over which same travels and on which the end-fitting of the torch is in permanent rotation, such a rod possibly being removably screw-fastened or click-fastened to the end-fitting of the torch, thereby allowing a rod of suitable length to be chosen and changed at will.

Other features and advantages of the invention will become apparent from the following description of an example embodiment. Reference will be made to the appended drawings, in which:

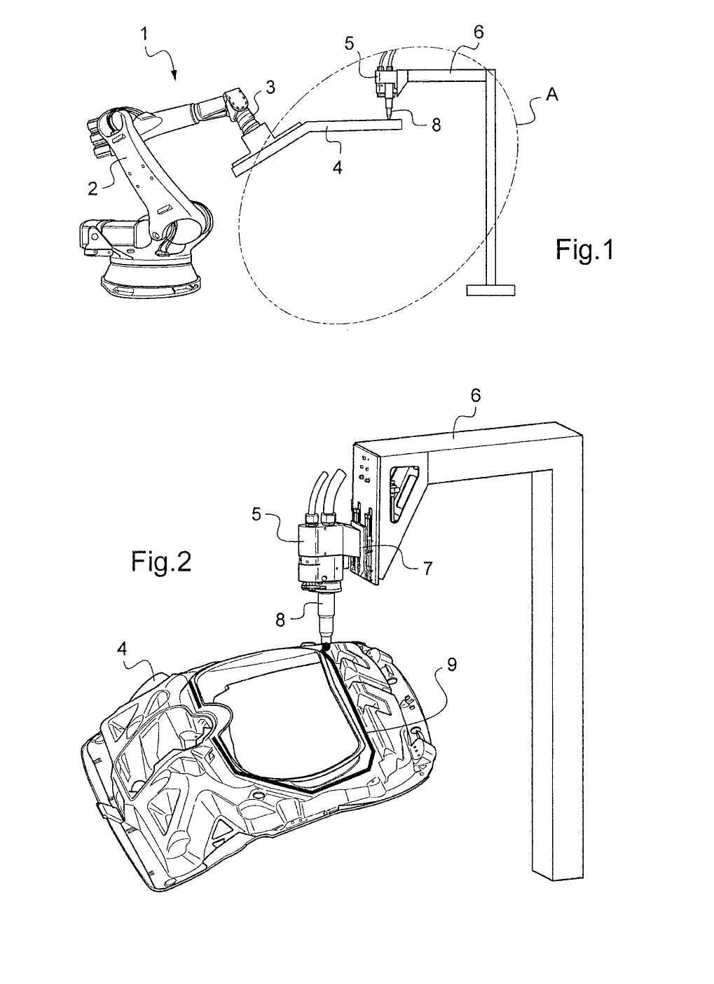

FIG. 1 is a schematic view of a device according to the invention;

FIG. 2 is an enlarged view of the detail A in FIG. 1;

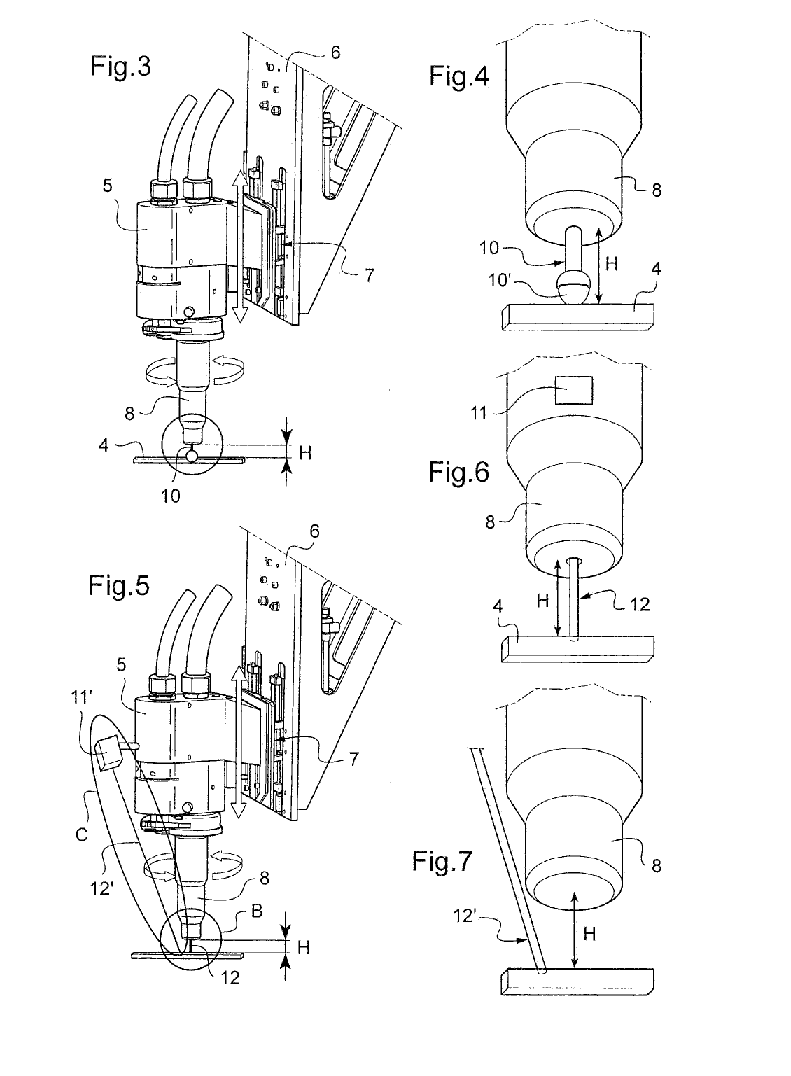

FIG. 3 is a detailed view of the plasma torch of the device of the invention, which torch is equipped with a first embodiment of the distance controlling system;

FIG. 4 is a detailed view of the distance controlling system mounted on the end of the plasma torch; and

FIG. 5 is a detailed view of the plasma torch of the device of the invention, equipped with a second embodiment of the distance controlling system, according to two variants B and C shown in greater detail in FIGS. 6 and 7, respectively.

FIGS. 1 and 2 show the robotic surface treatment device 1; it comprises:

on the one hand, a handling robot 2 the end of an articulated arm 3 of which bears a workpiece 4, for example an automotive vehicle part made of molded thermoplastic, in the present case in the application shown a thermoplastic tailgate; and

on the other hand, a vertical plasma torch 5 borne at the end of a scaffold 6 by way of a carriage that is able to slide along the axis of the plasma torch 5, here vertically, and that is centered on a position of equilibrium (the scaffold 6 is for example fixed to the ground).

The end-fitting 8 of the torch 5 directs a plasma jet onto the part 4, which jet erodes the part along a track 9 defined on the part 4 by the movement of the handling robot 2 (naturally the opposite arrangement could be used, with a stationary part and a torch borne by the handling robot). In the application shown, this track 9 corresponds to the zone where the rear windshield on the thermoplastic tailgate 4 is attached. The end-fitting 8 of the torch 5 is cylindrical and in rotation about its vertical axis.

The invention aims to provide this robotic device with means for controlling the distance between the end-fitting 8 of the torch 5 and the part 4, and to do so throughout the high-speed dynamic working process.

According to a first solution shown in FIGS. 4 and 5, at the lower end of the end-fitting 8, a rod 10, which is preferably removable, is provided, said rod 10 being coaxial with the end-fitting 8: the rod 10 may for example be screw-fastenable to the end of the end-fitting 8. This rod 10 makes it possible to maintain a distance H with the part 4 and therefore to obviate divergence problems since, because it makes contact with the part, the rod will absorb path divergences via the movable carriage 7, to which a counter-reaction may be added, if necessary, to ensure contact with the rod 10 connected to the torch 5 is maintained as the part 4 travels under the torch 5 (vibration under the effect of friction). The rod 10 may, if needs be, be equipped with a caged ball 10′ in order to prevent the part 4 from becoming scratched due to the rotation of the torch 5 and the translation of the part 4 under the rod (see FIG. 4). Since the rod 10 is removable, it is interchangeable and flexible in terms of height or with regard to wear and it may be dimensioned to obtain any required working height H.

According to a second embodiment of the means for controlling the distance H between the torch end-fitting 8 and the part 4, a laser sensor 11, or comparator, is incorporated in place of the rod 10, which laser sensor 11 or comparator emits a ray 12 onto the part 4 and measures the reflected ray so as to calculate and record dynamically the distance H between the torch 5 and the part 4, the movable carriage system 7 being or not being employed depending on whether or not it is desired to correct the distance between the torch 5 and the part 4 in real time. If it is desired to provide a real-time correction, the carriage 7 is motorized and servo-controlled via an electromechanical interface in order for the setpoint of the sensor to be processed and the position of the torch 5 to be corrected by the motorized movable carriage 7. If it is not possible or desired to correct this distance in real time, the movable carriage 7 is not required. In both situations, the advantage lies in the fact that it is possible to perform telemetry by dynamically recording the position of the torch 5 relative to the part 4 and thus define a tolerance range and obtain a continuous process control and thus delimit a tolerance range.

According to one variant of this solution, instead of incorporating the laser sensor 11 coaxially in the plasma torch, a laser sensor 11′ is provided offset from the plasma torch 5 and its axis, which is therefore simpler to implement. The laser ray 12′ is oblique but the laser target point is not located on the working axis of the torch 5 and only gives an indication of path divergence. Therefore, in this configuration it is not advantageous to servo-control an electromechanical correction of torch/part position via the movable carriage 7, but it may nonetheless be suitable for carrying out the online position control.

It is naturally possible and even advantageous to mix the above solutions. In particular it is possible to couple, on the one hand, a simple and purely mechanical solution employing the rod 10 and guaranteeing control of the distance between the torch 5 and the part 4, divergences of which will naturally be corrected via the mechanical principle by which contact is maintained, and, on the other hand, the solution for controlling online, with the sensor 11′, the plasma surface preparation process.

1-5. (canceled)

6. A robotic device for preparing a surface of a thermoplastic part with plasma, the device comprising:
first means for holding a thermoplastic part; and
second means for holding a plasma torch and including a rotary cylindrical end-fitting;
the first and/or second holding means being movable so that the torch and the part have a relative movement allowing the torch to travel over a treatment zone of the part;
the device further comprising, on the plasma torch, means for controlling a distance between the end-fitting of the torch and the part, wherein the controlling means comprises a rod placed axially on the end-fitting of the plasma torch; and
a carriage that is movable in a direction of the axis of the torch, which carriage is interposed between the movable torch and the second holding means, and wherein the movable carriage comprises means for producing a counter-reaction to a movement about a position of equilibrium or abutment.

7. The device as claimed in claim 6, wherein the first holding means includes a handling robot.

8. The device as claimed in claim 6, wherein the second holding means includes a fixed scaffold.

9. The device as claimed in claim 6, wherein the movable carriage comprises motorized means for moving the torch in a direction of its axis.

10. The device as claimed in claim 11, wherein the rod comprises a caged ball at its end.
